(19) United States
(12) Patent Application Publication
(10) Pub. No.: US 2016/0042097 A1
(43) Pub. Date: Feb. 11, 2016

(54) SYSTEM AND METHOD FOR CONCURRENT MULTI-USER ANALYSIS OF DESIGN MODELS

(71) Applicant: Brigham Young University, Provo, UT (US)

(72) Inventors: Jared Calvin Briggs, Payson, UT (US); Ammon Hepworth, Provo, UT (US)

(21) Appl. No.: 14/821,430

(22) Filed: Aug. 7, 2015

Related U.S. Application Data
(60) Provisional application No. 62/034,311, filed on Aug. 7, 2014.

(51) Int. Cl. G06F 17/50

(52) U.S. Cl. CPC G06F 17/50

(57) ABSTRACT

A computer-implemented method for concurrent multi-user analysis of design models may include (1) receiving a change descriptor resulting from a model change request on a local copy of a design model, (2) submitting the change descriptor to a server for application to a shared copy of the design model, (3) receiving, from the server, shared model data corresponding to the change descriptor, and (4) applying the shared model data to the local design model. Various other methods and systems are also disclosed.

### CROSS-REFERENCE TO RELATED APPLICATIONS

This application claims the benefit of U.S. provisional application 62/034,311 entitled “Multi-user FEA Pre-processing” and filed on 7 Aug. 2014. The foregoing application is incorporated herein by reference.

### BACKGROUND

The subject matter disclosed herein relates to computer-aided design and analysis, and apparatus, systems, means, and methods for multi-user analysis in particular.

As part of any modern product design method, it is common practice to analyze a product before it is produced in order to predict whether it will perform according to the required design criteria. Products are commonly analyzed for conditions such as stress, strain, deflection, failure, heat and mass transfer conditions, etc. Unfortunately, the vast majority of products have geometries, materials, loads, environments, or a combination of these that are too complex to accurately model using simple, closed-form solutions. Therefore, methods have been developed to facilitate the numerical approximation of these products, thus enabling the computational simulation of their real-world performance. These include the Finite Difference, Finite Volume, and Finite Element methods, the uses of which are often very time-intensive—yet critical—in the product design process.

Modern engineering applications that facilitate the use of finite analysis methods are currently limited to a single user and processing thread. This means that only a single engineer can work on an analysis model at a time using software that executes on a single processor, even in cases where the model is extremely large. For example, when a product is designed, a Computer-Aided Design (CAD) geometry model is delivered to a single analyst who de-features it, defines an appropriate mesh, refines the mesh, applies realistic boundary conditions, and then submits the simulation model to be solved—often to a High Performance Computing (HPC) cluster or other cloud-type environment. This serial workflow may cause the single-user preparation of analysis modules to become a substantial bottleneck in the product design process. Although much research has been done to expedite the overall analysis process, pre-processing environments remain oriented toward a single user.

Given the foregoing, what is needed is additional and improved systems and methods for finite analysis pre-processing, in particular, systems and methods that facilitate multiple simultaneous users. The embodiments disclosed herein were developed in response to these issues.

### SUMMARY

As will be described in greater detail below, the subject matter disclosed herein describes various systems and methods for providing concurrent multi-user analysis of design models. In one example, a computer-implemented method for may include (1) receiving a change descriptor resulting from a model change request on a local copy of a design model, (2) submitting the change descriptor to a server for application to a shared copy of the design model, (3) receiving, from the server, shared model data corresponding to the change descriptor, and (4) applying the shared model data to the local design model.

In some examples, receiving the change descriptor resulting from the model change request on the local copy of the design model may include performing the model change request on the local design model and extracting, from the local design model, data resulting from performing the model change request to produce the change descriptor. In some examples, receiving the change descriptor resulting from the model change request on the local copy of the design model may include determining that the data that would result from the model change request can be determined without performing the model change request and obtaining the data that would result from the model change request without performing the model change request.

In one embodiment, the shared model data differs from the change descriptor, and applying the shared model data to the local design model includes reversing the model change request on the local design model and inserting the shared model data into the local design model. In some examples, reversing the model change request from the local design model may include saving at least a portion of the local design model before performing the model change request on the local design model and restoring the saved portion of the local design model to the local design model after performing the model change request.

In one embodiment, the shared model data is identical to the change descriptor and applying the shared model data to the local design model includes permitting the change descriptor to remain in the local design model without reversing the model change request or inserting the shared model data into the local copy of the design model. In one embodiment, where the shared model data is identical to the change descriptor, the server may transmit an indication that the shared model data is identical to the change descriptor. In some examples, receiving the change descriptor resulting from the model change request on the local copy of the design model may include constructing a JavaScript object notation representation of the data resulting from the model change request. In some examples, receiving the change descriptor resulting from the model change request on the local copy of the design model may include constructing an extensible markup language representation of the data resulting from the model change request.

In one embodiment, a method for concurrent multi-user analysis of design models may include (1) receiving, from a first client, a change descriptor resulting from a model change request on a local copy of a design model for application to a shared copy of the design model, (2) index shifting the change descriptor from the first client for application to the shared design model, (3) applying the index-shifted change descriptor to the shared design model, (4) submitting the index-shifted change descriptor to the first client for application to the local design model, and (5) submitting the index-shifted change descriptor to at least one additional client for application to an additional local design model maintained by the additional client.

In some examples, index shifting the data from the first client may include determining that an object identifier for one or more new data objects included in the data from the first client matches an object identifier of an existing data object in the shared copy of the design model and assigning a unique object identifier to the new data object before applying the index-shifted change descriptor to the shared copy of the design model. In some examples, index shifting the change descriptor from the first client may include determining that the object identifier for at least one new data object included in the data from the first client does not match the object identifier of any existing data object in the shared design model.

In some examples, determining that the object identifier for the new data object does not match the object identifier of any existing object in the shared design module may include determining that the object identifier for the new data object is greater than a maximum identifier value for the shared design model. In some examples, the computer-implemented method may further include updating the maximum identifier value to a value greater than the object identifier for the new data object.

In one embodiment, a system for implementing the above-described method may include several modules stored in memory, such as (1) a change description module that receives the change descriptor resulting from a model change request on a local copy of a design model, (2) a communication module that (a) submits the change descriptor to a server for application to a shared copy of the design model and (b) receives, from the server, shared model data corresponding to the change descriptor, (3) an application module that applies the shared model data to the local design model. The system may also include one or more physical processors configured to execute the change description module, the communication module, and the application module.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic drawing of a system wherein a multi-user analysis system may be deployed, in accordance with at least one embodiment of the present invention;

FIG. 2 is a functional block diagram depicting one embodiment of the system for concurrent multi-user analysis of design models;

FIG. 3 is a functional block diagram depicting one embodiment of the system for concurrent multi-user analysis of design models;

FIG. 4 is a flowchart diagram depicting one embodiment of a method for providing concurrent multi-user analysis of design models;

FIG. 5 is a flowchart diagram depicting one embodiment of a method for providing concurrent multi-user analysis of design models; and

FIG. 6 is a block diagram depicting example data within a design model, in accordance with at least one embodiment of the present invention.

### DETAILED DESCRIPTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, enable the module to achieve the intended purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure is generally directed to systems and methods for concurrent multi-user analysis of design models. As will be explained in greater detail below, systems and methods described herein may facilitate concurrent multi-user analysis by using a hybrid client-server architecture that allows users to use familiar analysis tools, with the server reconciling changes made by users on separate clients with a shared design model maintained by the server. Concurrent multi-user analysis may permit faster analysis of a shared design model than is possible with single-user systems.

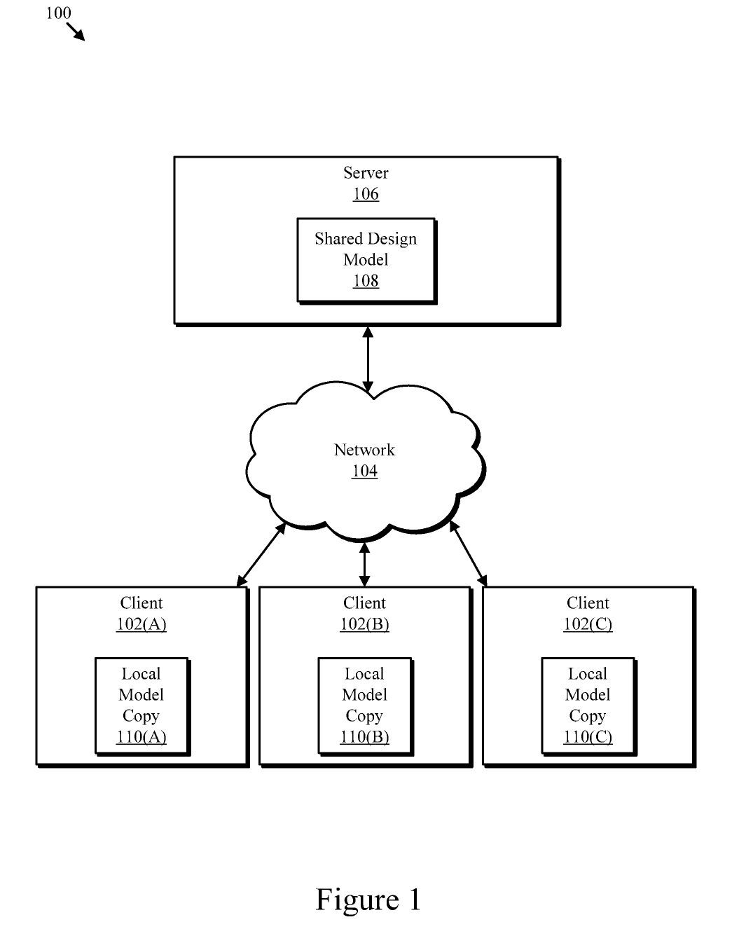

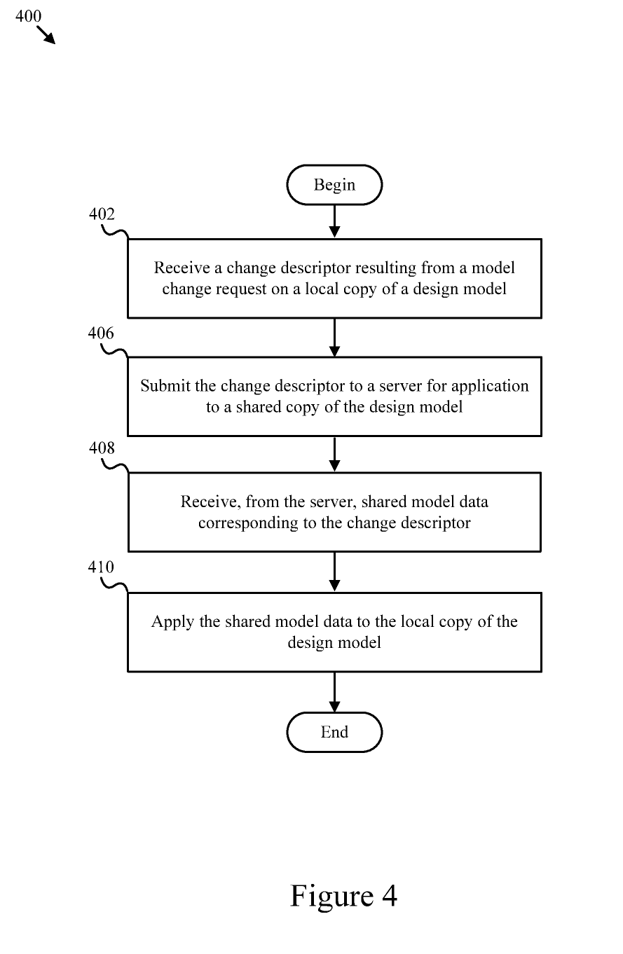

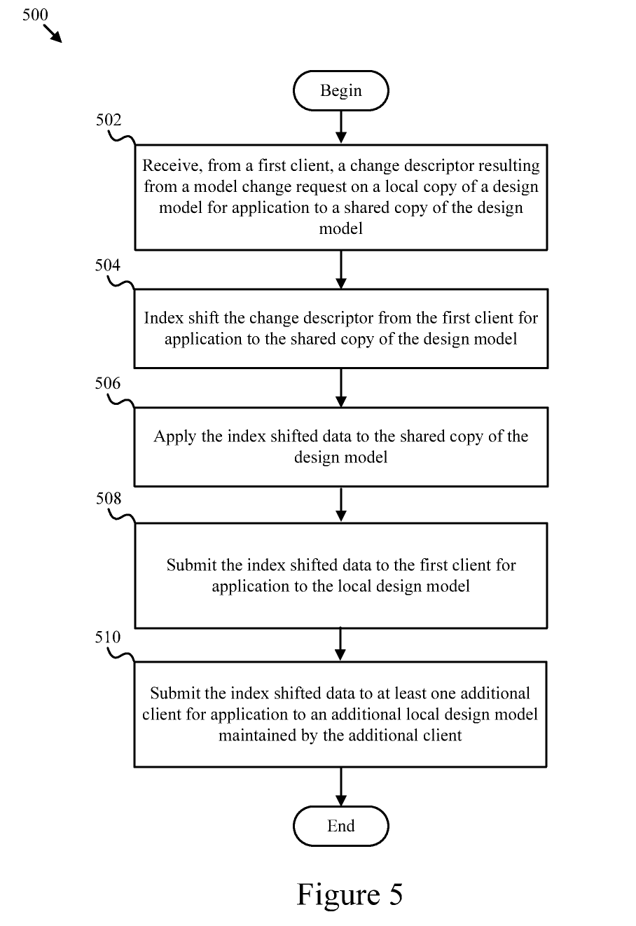

The following will provide, with reference to FIGS. 1-3 and 6, detailed descriptions of example systems for concurrent multi-user analysis of design models. Detailed descriptions of corresponding computer-implemented methods will also be provided in connection with FIGS. 4 and 5.

FIG. 1 is a schematic drawing of a system 100 wherein a multi-user analysis system may be deployed. As illustrated in this figure, system 100 may include one or more clients 102, a network 104, and a server 106. Server 106 may host a shared (i.e., global) design model 108. Clients 102 may host local model copies 110 that include at least of portion of shared design model 108.

Clients 102 generally represent any type or form of computing device capable of reading computer-executable instructions. Examples of clients 102 include, without limitation, laptops, tablets, desktops, servers, combinations of one or more of the same, or any other suitable computing device.

Server 106 generally represents any type or form of computing device or combinations of computing devices that is capable of storing, comparing, and/or providing data, as well as providing back-end processing services. Server 106 may represent a commercial or publicly-accessible service or a service provided to a single organization. Examples of server 106 include, without limitation, high-performance clusters, virtual machines, application servers, web servers, and/or database servers configured to provide various database services and/or run software applications, or combinations of one or more of the same.

In certain embodiments, server 106 may represent combinations of software applications and physical computing systems configured to perform various tasks. For example, server 106 may include a database server that manages one or more databases, such as shared design model 108. In one example, shared design model 108 may be configured to store geometry, material, load, and/or environment data representing one or more design models. Shared design model 108 may represent portions of a single database or computing device or a plurality of databases or computing devices capable of being accessed by computing devices included in server 106 and/or clients 102.

Network 104 generally represents any medium or architecture capable of facilitating communication or data transfer. Examples of network 104 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), or the like. Network 104 may facilitate communication or data transfer using wireless or wired connections. In one embodiment, network 104 may facilitate communication between clients 102 and server 106.

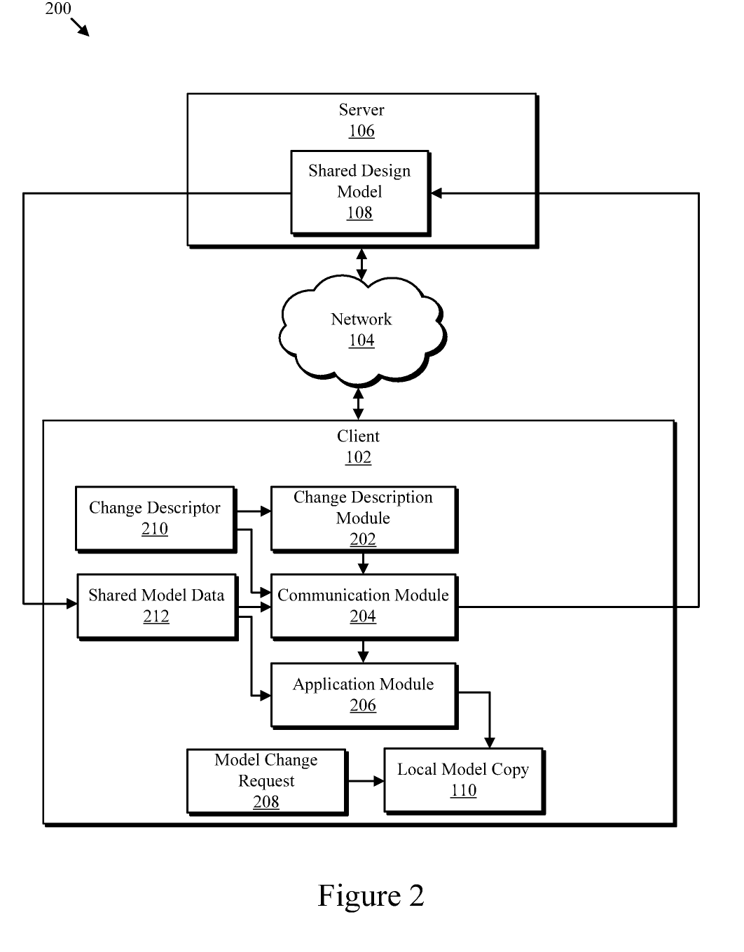

FIG. 2 is a functional block diagram depicting one embodiment of a system 200 for providing concurrent multi-user analysis of design models. As illustrated in this figure, system 200 may include a client 102 that may include local model copy 110, network 104, and a server 106 with a shared design model 108, as well as one or more modules for performing one or more tasks. For example, and as will be described in greater detail below, change description module 202 may receive the change descriptor 210 resulting from a model change request 208 on a local model copy 110 of a design model. Communication module 204 may submit change descriptor 210 to server 106 for application to shared design model 108. Communication module 204 may receive, from server 106, shared model data 212 corresponding to change descriptor 210. Application module 26 may apply shared model data 212 to local model copy 110. The system 200 is one particular embodiment of the system 100.

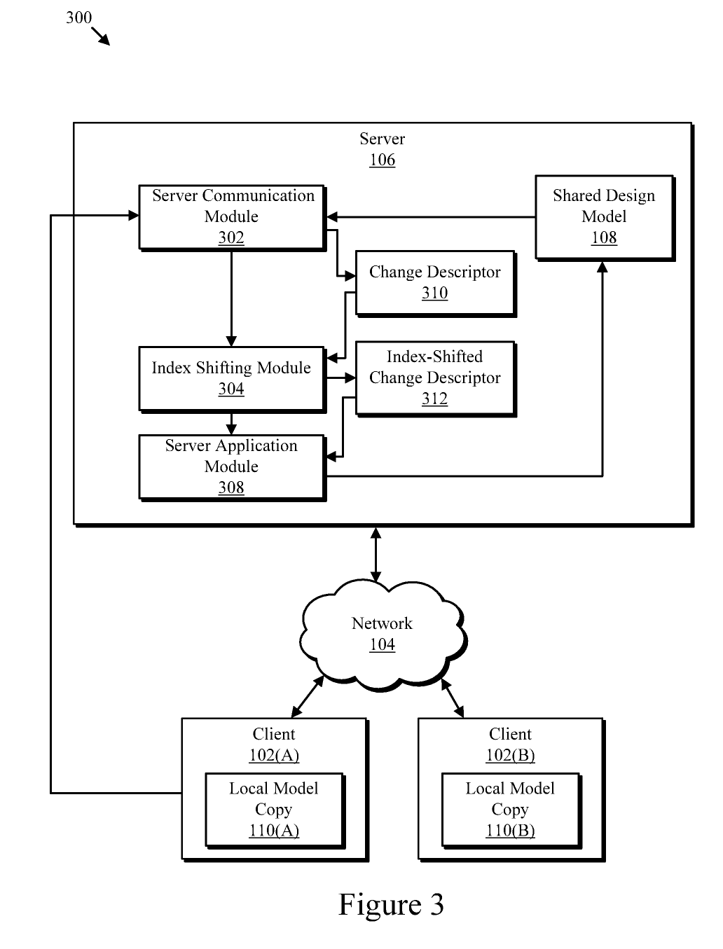

FIG. 3 is a functional block diagram depicting one embodiment of a system 300 for concurrent multi-user analysis of design models. As illustrated in this figure, system 300 may include one or more clients 102, each of which may include a local model copy 110. System 300 may also include network 104 and server 106 with shared design model 108, as well as one or more modules for performing one or more tasks. For example, and as will be described in greater detail below, server communication module 302 may receive from client 102(A) a change descriptor 310 resulting from a model change request on local model copy 110(A) on client 102(A). Server communication module 302 may submit change descriptor 310 to index shifting module 304, which may index shift change descriptor 310 to produce index-shifted change descriptor 312 for application to shared design module 108. Server application module 308 may apply index-shifted change descriptor 312 to shared design model 108. Server communication module 302 may then submit index-shifted change descriptor 312 to client 102(A) for application to local model copy 110(A). Server communication module 302 may also submit index-shifted change descriptor 312 to one or more additional clients 102 for application to additional local model copies 110, maintained by the additional clients 102.

FIG. 4 is a flow diagram of an example computer-implemented method 400 for providing concurrent multi-user analysis of design models. The steps shown in FIG. 4 may be performed by any suitable computer-executable code and/or computing system. In some embodiments, the steps shown in FIG. 4 (as well as FIG. 5) may be performed by the server 106, one or more clients 102, or partitioned across the server 106 and one or more clients 102.

As illustrated in FIG. 4, at step 402, one or more of the systems described herein may receive the change descriptor resulting from a model change request on a local copy of a design model. For example, change description module 202 may, as part of client 102 in FIG. 2, receive change descriptor 210 resulting from model change request 208 on local model copy 110.

Change description module 202 may receive the change descriptor in a variety of ways. For example, change description module 202 may receive the change descriptor by performing a model change request on the local design model, then extracting, from the local design model, data resulting from performing the model change request. In one embodiment, change description module 202 may be a plug-in or extension to an analysis application that makes use of application programming interfaces (APIs) of the analysis application to detect commands executed by a user or detects application events to identify commands operating on the design model, or to compare changes to design model data before and after the user issues an analysis command.

In another example, change description module 202 may receive the change descriptor by determining that the data that would result from the model change request can be determined without performing the model change request, and then obtaining the data that would result from the model change request without first performing the model change request. For example, change description module 202 may determine that a command that applies a load to a specified node would have no effect on objects other than the specified node.

In some examples, change description module 202 may receive the change descriptor by constructing a data exchange representation of the data resulting from the model change request using notations such as extensible markup language (XML), JavaScript object notation (JSON), or any other suitable representation of the data.

At step 404, one or more of the systems described herein may submit the change descriptor to a server for application to a shared copy of the design model. For example, communication module 204 may, as part of client 102 in FIG. 2, submit change descriptor 210 to server 106 for application to shared design model 108.

Communication module 204 may submit the change descriptor to the server in a variety of ways. For example, the server may maintain a network connection to each client to allow two-way communication between the server and each client. In another example, each client may have two connections to the server, with one connection for submitting change descriptors to a queue on the server and another connection for receiving data from the server. By maintaining a queue, the server may apply updates to the shared design model in the order they were made on the clients. In another example, the client and server may communicate using remote database protocols. For example, the server may use a commercial database management system both for storing shared design model data and for communicating with clients, thereby taking advantage of data integrity features associated with database management systems.

At step 406, one or more of the systems described herein may receive, from the server, shared model data corresponding to the change descriptor. For example, communication module 204 may, as part of client 102 in FIG. 2, receive, from server 106, shared model data 212 corresponding to change descriptor 210.

Communication module 204 may receive shared model data from the server in any suitable manner. For example, as described above, communication module 204 may maintain a single network connection with the server to facilitate two-way communication between the server and the client, maintain separate connections for submitting change descriptors to a server queue and receiving shared model data change descriptors from the server, or use remote database protocols to receive data from the server.

At step 408, one or more of the systems described herein may apply the shared model data to the local copy of the design model. For example, application module 206 may, as part of client 102 in FIG. 2, apply shared model data 212 to local model copy 110.

Application module 206 may apply shared model data to the local copy of the design model in a variety of ways. For example, application module 206 may determine that the shared model data received from the server is identical to the change descriptor the client submitted to the server, and that no further action is required, as the current state of the local model copy has been synchronized with the shared design model on the server.

In another example, the server determines that the change descriptor submitted by the client can be applied to the shared design model without modification. Instead of transmitting the unmodified change descriptor back to the client, the server may simply notify the client that the change descriptor has been applied to the shared design model, unmodified, and that no further action by the client is required to apply shared model data to the local copy of the design model.

In another example, the client receives shared model data from the server that differs from the change descriptor the client submitted to the server. Application module 206 may then apply the shared model data to the local copy of the design model by first reversing the model change request previously applied to the local design model, then inserting the shared model data into the local design model. In one example, reversing the model change request from the local design model may include saving a portion of the local design model before performing the model change request on the local design model, then, after the shared model data has been received from the server and application module 206 determines that the model change request must be reversed, restoring the saved portion of the local design model before applying the shared model data to the local model copy.

FIG. 5 is a flow diagram of an example computer-implemented method 500 for providing concurrent multi-user analysis of design models. The steps shown in FIG. 5 may be performed by any suitable computer-executable code and/or computing system. In some embodiments, the steps shown in FIG. 5 (as well as FIG. 4) may be performed by the server 106, one or more clients 102, or partitioned across the server 106 and one or more clients 102.

At step 502, one or more of the systems described herein may receive, from a first client, a change descriptor resulting from a model change request on a local copy of a design model for application to a shared copy of the design model. For example, server communication module 302 may, as part of server 106 in FIG. 3, receive change descriptor 310 from client 102(A) for application to shared design model 108 on server 106. Change descriptor 310 may have resulted from a model change request to local model copy 110(A) on client 102(A).

Server communication module 302 may receive a change descriptor in a variety of ways. For example, as described above, server communication module 302 may maintain a network connection to each client to allow two-way communication between the server and each client. In another example, server communication module may maintain two connections with each client, with one connection that allows each client to submit change descriptors to a queue on the server and another connection for sending data to the client. By maintaining a queue, the server may apply updates to the shared design model in the order they were made on the clients. In another example, the server may communicate with clients using database protocols. For example, the server may use a commercial database management system both for storing shared design model data and for communicating with clients, thereby taking advantage of data integrity features associated with database management systems.

At step 504, one or more of the systems described herein may index shift the change descriptor from the first client for application to the shared copy of the design model. For example, index shifting module 304 may, as part of server 106 in FIG. 3, index shift change descriptor 310 from client 102(A) to produce index-shifted change descriptor 312 for application to shared design model 108.

Index shifting module 304 may index shift the change descriptor in a variety of ways. For example, index shifting module 304 may include determining that an object identifier for at least one new data object included in the data from the first client matches an object identifier of an existing data object in the shared copy of the design model, and assigning a unique object identifier to the new data object before applying the index-shifted change descriptor to the shared copy of the design model. An object identifier for a new data object may match an object identifier for an existing data object in the shared design model if a second client has added a data object to the shared data model, but the client submitting the change descriptor that includes the new data object has not yet received and applied a change descriptor for the data object added by the second client.

In another example, index shifting the change descriptor from the first client may include determining that the object identifier for one or more new data objects included in the data from the first client do not match the object identifier of any existing data object in the shared design model. In this example, index shifting module 304 may pass the change descriptor received from the client to server application module 308, unmodified.

In one example, determining that the object identifier for the new data object does not match the object identifier of any existing object in the shared design module may include determining that the object identifier for the new data object is greater than a maximum identifier value for the shared design model. Index shifting module may maintain a maximum identifier value for the shared design model, with new data objects assigned object identifiers increasing in magnitude as they are added to the shared design model. Index shifting module 304 may determine whether the object identifier for a new data object received in a change descriptor from a client matches any existing object identifier simply by comparing the object identifier for the new data object to the maximum identifier value.

Index shifting module 304 may use any other suitable method for determining whether the object identifier of a new data object matches the object identifier for an existing object in the share design model. For example, server 106 may utilize a database management system for storing the shared design model that includes an indexing method for design object records that assures that each data object has a unique object identifier.

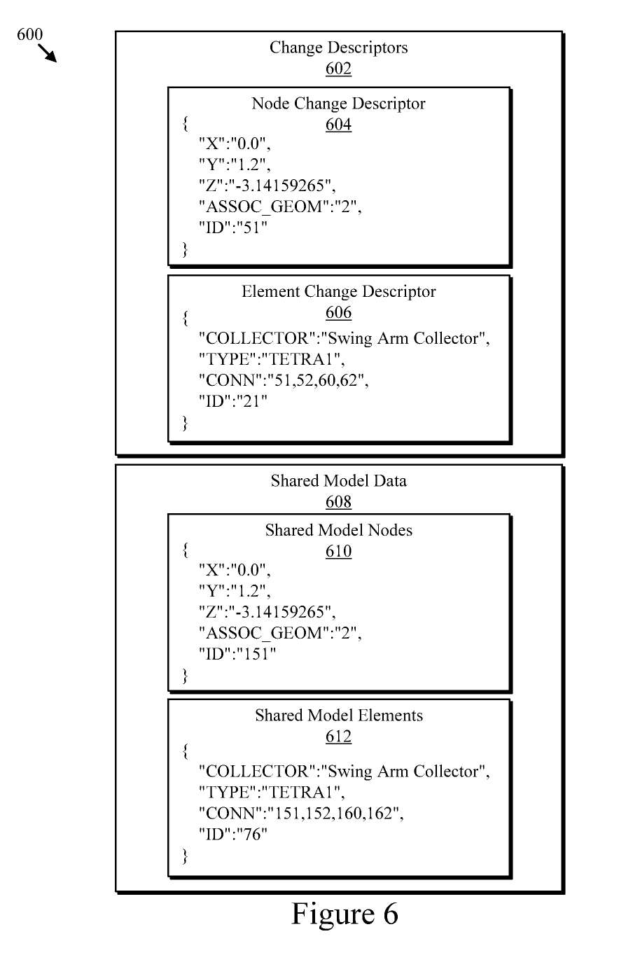

FIG. 6 is a block diagram depicting example data 600 within a design model, in accordance with at least one embodiment of the present invention. Example data 600 may include change descriptors 602, representing node change descriptor data 604 and element change descriptor data 606, submitted by a client to a server for application to a shared design model. For example, as depicted in FIG. 2, change descriptors 602 may represent data resulting from model change request 208 to local model copy 110, which change description module 202 has extracted from local model copy 110 for communication module 204 to transmit to server 106 as change descriptor 210.

Example data 600 may also include shared model data 608, which includes shared model nodes 610 and shared model elements 612, corresponding to node change descriptor 604 and element change descriptor 606, respectively. For example, as shown in FIG. 3, shared model data 608 may represent data resulting from index shifting module 304 index shifting change descriptors 602 received as change descriptor 310, to produce index-shifted change descriptor 312, for application to shared design model 108, and to be transmitted to clients 102 for application to local model copies 110.

Comparing change descriptors 602 with shared model data 608 indicates how index shifting module 304 may modify change descriptor data from a client for application to a shared design model on a server. Before the client submitted change descriptors 602 to the server, the local copy of the design model on the client may have included nodes 1-50 and elements 1-20. A mesh creation operation may create 200 new nodes and 100 new elements. The client may then submit change descriptors 602 to the server, with node change descriptor 604 indicating that the new nodes created in the local model copy were numbered starting with ID 51, and elements numbered starting with ID 21, as shown in element change descriptor 606. Unknown to the client, other clients may have already created 100 additional nodes and 55 additional elements, so that the shared design model on the server already contains nodes 1-150 and elements 1-75. The server may then renumber the nodes created by the first client beginning with ID 151, as shown in shared model nodes 610, and the elements created by the first client beginning with ID 76, as shown in shared model elements 612. The server may then transmit the index-shifted change descriptors as shared model data 608 to all clients for application to their local model copies.

Returning to FIG. 5, at step 506, one or more of the systems described herein may apply the index-shifted change descriptor to the shared copy of the design model. For example, server application module 308 may, as part of server 106 in FIG. 3, apply index-shifted change descriptor 312 to shared design model 108 on server 106.

Server application module 308 may apply the index-shifted change descriptor to the shared copy of the design model in a variety of ways. For example, server 106 may have a copy of the same design application used by the client, which server application module 308 may use to apply the index-shifted change descriptor to the shared design model. In another example, server application module 308 may apply the index-shifted change descriptor by adding the data to a database containing the shared design model.

At steps 508 and 510, one or more of the systems described herein may submit the index-shifted change descriptor to the first client for application to the local design model and to one or more additional clients for application to additional local copies of the design model maintained by additional clients. For example, server communication module 302 may, as part of server 106 in FIG. 3, submit index-shifted change descriptor 312 to client 102(A) for application to local model copy 110(A), maintained by client 102(A) and to client 102(B) for application to local model copy 110(B).

As described above, systems and methods described herein may facilitate multi-user analysis of a shared design model by submitting changes made by users on separate clients to a server that reconciles the changes with a shared design model. The server may then propagate the changes to the shared design model back to each of the clients, for application to local copies of the design model. In this way, systems and methods described herein may maintain the integrity and coherence of the design model while multiple users concurrently perform analysis operates on the shared model, which may permit faster analysis of the model than is possible with single-user systems.

It should also be understood that this description is not intended to limit the invention. On the contrary, the example embodiments are intended to cover alternatives, modifications, and equivalents, which are included in the spirit and scope of the invention as defined by the appended claims. Further, in the detailed description of the example embodiments, numerous specific details are set forth in order to provide a comprehensive understanding of the claimed invention. However, one skilled in the art would understand that various embodiments may be practiced without such specific details.

Although the features and elements of the present example embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for concurrent multi-user analysis of design models, executed by at least one processor, the method comprising:
receiving a change descriptor resulting from a model change request on a local copy of a design model.
submitting the change descriptor to a server for application to a shared copy of the design model;
receiving, from the server, shared model data corresponding to the change descriptor;
applying the shared model data to the local design model.

2. The method of claim 1, wherein receiving the change descriptor resulting from the model change request on the local copy of the design model comprises:
performing the model change request on the local design model;
extracting, from the local design model, data resulting from performing the model change request to produce the change descriptor.

3. The method of claim 1, wherein receiving the change descriptor resulting from the model change request on the local copy of the design model comprises:
determining that the data that would result from the model change request can be determined without performing the model change request;
obtaining the data that would result from the model change request without performing the model change request.

4. The method of claim 1, wherein:
the shared model data differs from the change descriptor;
applying the shared model data to the local design model comprises:
reversing the model change request on the local design model;
inserting the shared model data into the local design model.

5. The method of claim 4, wherein reversing the model change request from the local design model comprises:
saving at least a portion of the local design model before performing the model change request on the local design model;
restoring the saved portion of the local design model to the local design model after performing the model change request.

6. The method of claim 1, wherein:
the shared model data is identical to the change descriptor;
applying the shared model data to the local design model comprises permitting the change descriptor to remain in the local design model without reversing the model change request or inserting the shared model data into the local copy of the design model.

7. The method of claim 6, wherein receiving, from the server, shared model data corresponding to the change descriptor wherein the shared model data is identical to the change descriptor comprises receiving an indication from the server that the shared model data is identical to the change descriptor.

8. The method of claim 1, wherein receiving the change descriptor resulting from the model change request on the local copy of the design model comprises constructing a JavaScript object notation representation of the data resulting from the model change request.

9. The method of claim 1, wherein receiving the change descriptor resulting from the model change request on the local copy of the design model comprises constructing an extensible markup language representation of the data resulting from the model change request.

10. A method for concurrent multi-user analysis of design models, executed by at least one processor, the method comprising:
receiving, from a first client, a change descriptor resulting from a model change request on a local copy of a design model for application to a shared copy of the design model;
index shifting the change descriptor from the first client for application to the shared design model;
applying the index-shifted change descriptor to the shared design model;
submitting the index-shifted change descriptor to the first client for application to the local design model;
submitting the index-shifted change descriptor to at least one additional client for application to an additional local design model maintained by the additional client.

11. The method of claim 10, wherein index shifting the change descriptor from the first client comprises:
determining that an object identifier for at least one new data object included in the change descriptor from the first client matches an object identifier of an existing data object in the shared copy of the design model;
assigning a unique object identifier to the new data object before applying the index-shifted change descriptor to the shared copy of the design model.

12. The method of claim 10, wherein index shifting the change descriptor from the first client comprises determining that an object identifier for at least one new data object included in the change descriptor from the first client does not match an object identifier of any existing data object in the shared design model.

13. The method of claim 10:
wherein determining that the object identifier for the new data object does not match the object identifier of any existing object in the shared copy of the design module comprises determining that the object identifier for the new data object is greater than a maximum identifier value for the shared design model;
further comprising updating the maximum identifier value to a value greater than the object identifier for the new data object.

14. A system for concurrent multi-user analysis of design models, the system comprising:
a change description module, stored in memory, that receives the change descriptor resulting from a model change request on a local copy of a design model.
a communication module, stored in memory, that:
submits the change descriptor to a server for application to a shared copy of the design model;
receives, from the server, shared model data corresponding to the change descriptor;
an application module, stored in memory, that applies the shared model data to the local design model;
at least one physical processor configured to execute the change description module, the communication module, and the application module.

15. The system of claim 14, wherein the change description module receives the change descriptor resulting from the model change request on the local copy of the design model by:
performing the model change request on the local design model;
extracting, from the local design model, data resulting from performing the model change request to produce the change descriptor.

16. The system of claim 14, wherein the change description module receives the change descriptor resulting from the model change request on the local copy of the design model by:
determining that the data that would result from the model change request can be determined without performing the model change request;
obtaining the data that would result from the model change request without performing the model change request.

17. The system of claim 14, wherein:
the shared model data differs from the change descriptor;
the application module applies the shared model data to the local design model by:
reversing the model change request on the local design model;
inserting the shared model data into the local design model.

18. The system of claim 17, wherein the application module reverses the model change request on the local design model by:
saving at least a portion of the local design model before performing the model change request on the local design model;
restoring the saved portion of the local design model to the local design model after performing the model change request.

19. The system of claim 14, wherein:
the shared model data is identical to the change descriptor;
the application module applies the shared model data to the local design model by permitting the change descriptor to remain in the local design model without reversing the model change request or inserting the shared model data into the local copy of the design model.

20. A system for concurrent multi-user analysis of design models, the system comprising:
a server communication module that receives, from a first client, a change descriptor resulting from a model change request on a local copy of a design model for application to a shared copy of the design model;
an index shifting module, stored in memory, that index shifts the change descriptor from the first client for application to the shared copy of the design model;
a server application module that applies the index-shifted change descriptor to the shared copy of the design model;
the server communication module further configured to:
submit the index-shifted change descriptor to the first client for application to the local design model;
submit the index-shifted change descriptor to at least one additional client for application to an additional local design model maintained by the additional client;
at least one physical processor configured to execute the server communication module, the index shifting module, and the server application module.
